(19) United States
(12) Patent Application Publication
(10) Pub. No.: US 2016/0205183 A1
(43) Pub. Date: Jul. 14, 2016

(54) METHOD AND APARATUS FOR BACKING UP DATA AND ELECTRONIC DEVICE

(71) Applicant: Xiaomi Inc., Beijing (CN)

(72) Inventors: Tiejun LIU, Beijing (CN); Wen LIU, Beijing (CN); Zheng LI, Beijing (CN)

(73) Assignee: Xiaomi Inc., Beijing (CN)

(21) Appl. No.: 14/881,672

(22) Filed: Oct. 13, 2015

Related U.S. Application Data
(63) Continuation of application No. PCT/CN2015/074584, filed on Mar. 19, 2015.

(30) Foreign Application Priority Data
Aug. 15, 2014 (CN) 201410404888.5

(51) Int. Cl. H04L 29/08

(52) U.S. Cl. CPC H04L 67/1095; H04L 67/1097

(57) ABSTRACT

The present disclosure relates to a method and an apparatus for backing up data, and an electronic device. The method includes: receiving backup data from a terminal; determining account information that the terminal has logged in to the electronic device; and storing the backup data to a path corresponding to the account information in the electronic device. By the technical solutions of the present disclosure, the backup data may be stored according to the account information, which helps to improve security and privacy of the backup data of each account, and facilitates router's management of backup data.

The present application is a continuation of International Application No. PCT/CN2015/074584, filed on Mar. 19, 2015, which is based upon and claims priority to Chinese Patent Application No. 201410404888.5, filed on Aug. 15, 2014, the entire contents of which are incorporated herein by reference.

### TECHNICAL FIELD

The present disclosure relates to a field of data backup technology, and more particularly to a method and an apparatus for backing up data, and an electronic device.

### BACKGROUND

As the mobile terminals include more and more functions, users may use the mobile terminals in various occasions, such as work and life, and store all kinds of data in the mobile terminal. When the mobile terminal is lost or damaged and the like, there exists the risk of losing data, or, when the user makes manual management due to insufficient storage space of the mobile terminal, some important data may be accidentally deleted.

In the related art, based on the intelligent development and application of a router, a hard disk with large capacity is configured in the router, so that the user may back up the data in the mobile terminal into the router, which not only ensures the data security, but also facilitates the user's viewing of the backup data.

However, how to promote management efficiency of the stored backup data by improving storage manner of the backup data stored in the router is not proposed in the related art.

### SUMMARY

The present disclosure provides a method and an apparatus for backing up data, and an electronic device, to solve the technical problem of low management efficiency of the backup data stored in a router is low

In a first aspect of the present disclosure, there is provided a method for backing up data, which may be implemented in a router device. In the method, the router device receives backup data from a terminal. The router device verifies account information that the terminal has logged in to the router device. The router device then stores the backup data to a path corresponding to the account information.

In a second aspect of the present disclosure, there is provided an electronic device. The electronic device may include: a processor; and a memory for storing instructions executable by the processor. The processor is configured to: receive backup data from a terminal; determine account information that the terminal has logged in; and store the backup data to a path corresponding to the account information.

In a third aspect of the present disclosure, there is provided a non-transitory computer readable storage medium. When instructions in the storage medium are executed by an electronic device, the electronic device may execute actions including: receiving backup data from a terminal; determining account information that the terminal has logged in to the electronic device; and storing the backup data to a path corresponding to the account information in the electronic device.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is an example flow chart illustrating a method for backing up data according to an exemplary embodiment.

FIG. 2 is an example organization structure diagram illustrating a path of backing up data according to an exemplary embodiment.

FIG. 3 is an example organization structure diagram illustrating another path of backing up data according to an exemplary embodiment.

FIG. 4 is an example flow chart illustrating a management to backup data according to an exemplary embodiment.

FIGS. 5-6 are example diagrams illustrating terminal interfaces according to an exemplary embodiment.

FIG. 7 is an example organization structure diagram illustrating a path of backing up data according to another exemplary embodiment.

FIG. 8 is an example organization structure diagram illustrating another path of backing up data according to another exemplary embodiment.

FIGS. 9-11 are example diagrams illustrating terminal interfaces according to an exemplary embodiment.

FIG. 12 is an example block diagram illustrating an apparatus for backing up data according to an exemplary embodiment.

FIG. 13 is an example block diagram illustrating an apparatus for backing up data according to an exemplary embodiment.

FIG. 14 is an example block diagram illustrating an apparatus for backing up data according to an exemplary embodiment.

FIG. 15 is an example block diagram illustrating an apparatus for backing up data according to an exemplary embodiment.

FIG. 16 is an example block diagram illustrating an apparatus for backing up data according to an exemplary embodiment.

FIG. 17 is an example block diagram illustrating an apparatus for backing up data according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Further, the different exemplary embodiments may be combined by a person having ordinary skill in the art.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

The technical solutions provided by the embodiments of the present disclosure may include the following advantageous effects:

The present disclosure stores the backup data according to the account information, so that access restrictions based on authority may be set between different accounts in advance, thereby improving security and privacy of the backup data, and helping the router to improve the management efficiency to the stored backup data.

The present disclosure also combines the account information with the device identification to manage the stored backup data, so that a more detailed storage management to the backup data is realized.

The present disclosure also classifies and stores the backup data according to the metadata information of the backup data, thereby facilitating a user's finding of the backup data, and also helping the router to improve the management efficiency of the backup data.

The present disclosure only also returns the information of the backup data corresponding to the account information according to the account information that the terminal has logged in, whereby it facilitates management of the backup data based on the account and backup data contents under other accounts may be also avoided to reveal, which helps to improve the security of the backup data.

The present disclosure also uses an account login mechanism so that the user only views and manages the backup data corresponding to the account that has been logged in, thereby facilitating the router's management of the backup data and also helping to improve the security of the backup data.

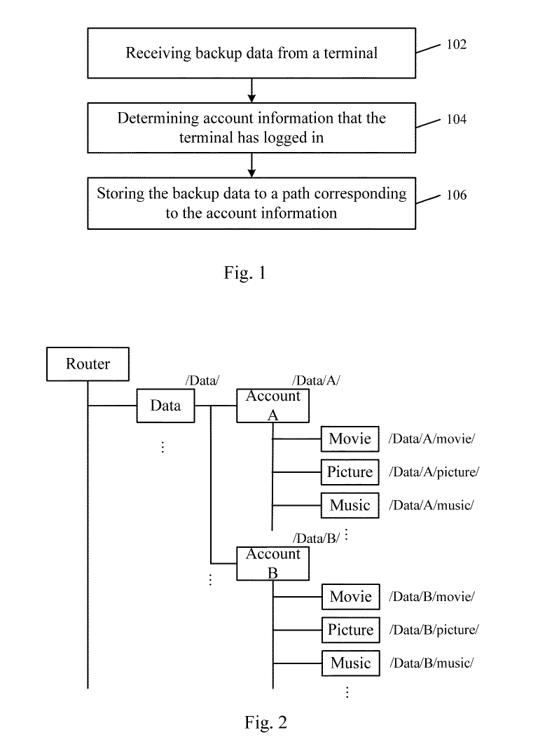

FIG. 1 is an example flow chart illustrating a method for backing up data according to an exemplary embodiment. As shown in FIG. 1, the method may be used in a router, and includes the following steps.

In step 102, the router receives backup data from a terminal. The backup data may include photo, mp3, video, mails, or any data from a terminal device.

In the embodiments, the terminal may implement the data backup in a router after joining a LAN (Local Area Network) created by the router. In an exemplary embodiment, after negotiating with the terminal and starting a backup function, the router determines that the data received from the terminal needs to be backed up. In another exemplary embodiment, the router may identify that a data packet belongs to the data that needs to be backed up from the terminal according to identification in the data packet received from the terminal.

In step 104, the router determines whether the terminal has logged in to the router using the account information.

In the embodiments, the router may inquire the account information that matches “a login account and a login password” according to a login request including the login account and the login password sent by the terminal, so as to realize account login of the terminal. As an exemplary embodiment, the router may verify the corresponding account information that the terminal has logged in according to the account identification in the corresponding data packet when receiving the backup data.

In step 106, the backup data is stored under a path corresponding to the account information in the router.

From the above described embodiment that, the present disclosure differentiates storage paths of backup data for different accounts in the router by account login mechanism, thereby facilitating the effective management of the backup data corresponding to the different accounts. For example, a user may copy files, delete files in the backup data on the router. The different accounts may relate to the same terminal. Alternatively or additionally, the different accounts may relate to different terminals.

When the router differentiates the storage path of the corresponding backup data according to the account information, a variety of organization structures may be adopted. The following detailed description will be made.

As an exemplary embodiment, FIG. 2 illustrates an organization structure of a data storage path: a first-level storage path of “data” is created in the router, and is for example: /Data/; in the first-level storage path /Data/, taking each account as a branch, a second-level storage path corresponding to each account is created, for example, the second-level storage path corresponding to an account A is: /Data/A/, and the second-level storage path corresponding to an account B is: /Data/B/; in each second-level storage path, taking each data type as a branch, a third-level storage path corresponding to each data type is created, for example, in the second-level storage path /Data/A/ corresponding to the account A, the third-level storage path created corresponding to the data type “movie” is: /Data/A/movie/, the third-level storage path created corresponding to the data type “picture” is: /Data/A/picture/, the third-level storage path created corresponding to the data type “music” is: /Data/A/music/, and the like.

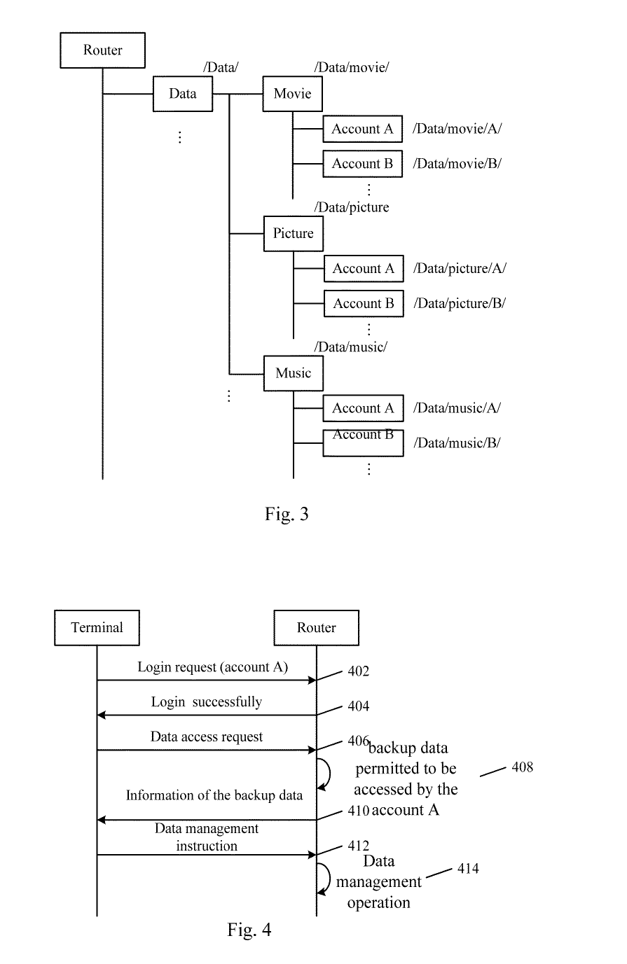

As another exemplary embodiment, FIG. 3 illustrates another organization structure of a data storage path: a first-level storage path of “data” is created in the router, and is for example: /Data/; in the first-level storage path /Data/, taking each data type as a branch, a second-level storage path corresponding to each data type is created, for example, the second-level storage path corresponding to the data type “movie” is: /Data/movie/, the second-level storage path corresponding to the data type “picture” is: /Data/picture/, and the second-level storage path corresponding to the data type “music” is: /Data/music/, and the like; in each second-level storage path, taking each account as a branch, a third-level storage path corresponding to each account is created, for example, in the second-level storage path /Data/movie/corresponding to “movie”, the third-level storage path created corresponding to an account A is: /Data/movie/A/, and the third-level storage path created corresponding to an account b is: /Data/movie/B/, and the like.

Based on the organization structure of the data storage path shown in FIG. 2 or FIG. 3, when the terminal transmits the backup data to the router, the router stores the backup data to the data storage path corresponding to the account information according to the account information that the terminal has logged in. Meanwhile, it is obvious for those skilled in the art that the organization structure of the data storage path in other forms may be applied in the technical solution of the present disclosure as long as the backup data corresponding to different login accounts of terminals may be stored correspondingly.

When the router adopts the organization structure of the data storage path as shown in FIG. 2 or FIG. 3, the user may manage operations related to the backup data corresponding to the login account information of the terminal through data interaction between the terminal and the router. The following detailed description will be made with reference to FIG. 4.

In step 402, suppose the terminal initiates a login request to the router by the account A.

In step 404, the router verifies the combination including a login account and a login password in the login request, and returns a message that the login is successful to the terminal after authenticating.

In step 406, the terminal sends a data access request to the router according to the account A that has logged in.

In step 408, the router determines the backup data that allows the account A to access.

In the embodiments, the user may set access authority on the backup data corresponding to the account that has logged in according to the actual needs. Therefore, the terminal may only access the backup data corresponding to the account A, or may also access the backup data having corresponding authority but corresponding to other account when logging in the account A.

In step 410, the router sends information of the backup data that allows the account A to access determined in the step 408 to the terminal.

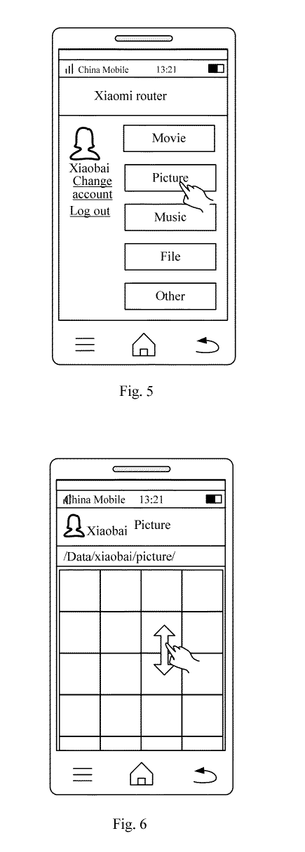

In the embodiments, as shown in FIG. 5, suppose the user logs in an account “xiaobai” through the terminal, and suppose the user may access the backup data corresponding to “xiaobai” in the router by clicking a button such as “movie”, “picture”, “music” and the like on a terminal interface. For example, when the user clicks a “picture” button, taking the organization structure of the data storage path shown in FIG. 2 as an example, the corresponding data storage path “/Data/xiaobai/picture/” may be entered into and shown by the interface shown in FIG. 6. A user may preview a thumbnail of a picture by sliding the user's fingers up and down on a touch screen. Further, the corresponding picture may also be displayed on full screen mode by clicking the thumbnail. Certainly, the above description only takes the organization structure of the data storage path shown in FIG. 2 herein as an example, and if the organization structure of the data storage path shown in FIG. 3 is adopted, when the user clicks the “picture” button, the entered data storage path may be “/Data/picture/xiaobai/”.

Further, since a plurality of devices of the same user, such as a mobile phone, a tablet PC and the like, or mobile phones of a plurality of users of the same family or the like may share the same account, the user may need the router to implement more sophisticated backup data management for each terminal device. Therefore, when the backup data from the terminal is stored to the path of the account information corresponding that the terminal has logged in, the router may further: acquire a device identification of the terminal; and determine a sub-path corresponding to the device identification in the path corresponding to the account information, and store the backup data to the sub-path corresponding to the device identification.

In the embodiments, considering the account information that the terminal has logged in and the device identification of the terminal at the same time, the organization structure corresponding to the data storage path may also be required to further expand when the router stores the backup data.

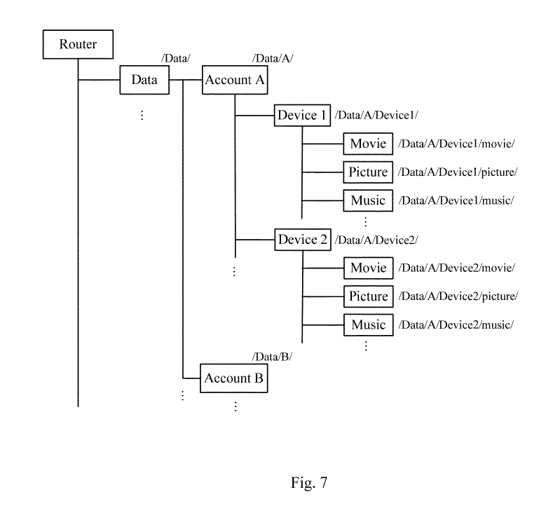

As an exemplary embodiment, the organization structure of the data storage path shown in FIG. 7 is expanded based on FIG. 2, including: under the second-level storage path corresponding to each account, the corresponding third-level storage paths are respectively created as for a plurality of terminal devices corresponding to each account, for example, suppose the account A is shared by a plurality of terminal devices such as a device 1, a device 2 and the like, under the second-level storage path /Data/A/ corresponding to the account A, the third-level storage path /Data/A/Device1/ corresponding to the device 1 and the third-level storage path /Data/A/Device2/ corresponding to the device 2 are respectively created; then, under the third-level storage path /Data/A/Device1/ corresponding to the device 1, a four-level storage path corresponding to each data type is created, for example, the four-level storage path /Data/A/Device1/movie/ corresponding to the data type “movie”, the four-level storage path /Data/A/Device1/picture/ corresponding to the data type “picture”, the four-level storage path /Data/A/Device1/music/ corresponding to the data type “music” and the like; and similarly, under the third-level storage path corresponding to each of the other devices such as the device 2 and the like, the corresponding four-level storage path may be created.

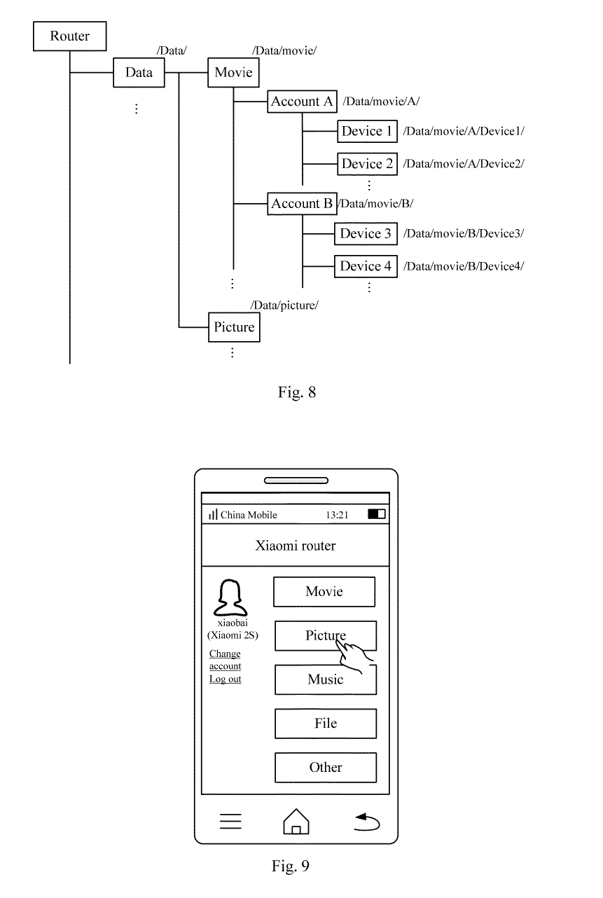

As another exemplary embodiment, the organization structure of the data storage path shown in FIG. 8 is expanded based on FIG. 3, including: in the third-level storage path corresponding to each account, the corresponding four-level storage paths are respectively created for a plurality of terminal devices corresponding to each account, for example, suppose the account A is shared by a plurality of terminal devices such as a device 1, a device 2 and the like, under the third-level storage path /Data/movie/A/ corresponding to the account A, the four-level storage path /Data/movie/A/Device1/ corresponding to the device 1 and the fourth-level storage path /Data/movie/A/Device2/ corresponding to the device 2 are respectively created; and similarly, under the third-level storage path corresponding to each of the other accounts such as the account B and the like, the corresponding four-level storage path is created for each device using the account.

The user may access and manage the backup data through the interface shown in FIG. 9 based on the organization structure of the data storage path shown in FIG. 7 or FIG. 8, or through data interactive procedure shown in FIG. 4. As shown in FIG. 9, suppose the user logs in an account “xiaobai” through the terminal, the router returns the information of the backup data of “xiaomi mobile phone 2S” (i.e., “xiaomi 2S” shown in FIG. 9) corresponding to “xiaobai” to the terminal after further determining that the type of the terminal is “xiaomi mobile phone 2S”, the corresponding backup data in the router may be accessed by clicking the button such as “movie”, “picture”, “music” and the like on the terminal interface.

According to an exemplary embodiment of the present disclosure, the backup data may include metadata information. Accordingly, the router may also read metadata information of the backup data from the terminal, classify the backup data according to the metadata information, determine a sub-path corresponding to a classification result under the path corresponding to the account information, and store the backup data to the sub-path corresponding to the classification result.

In the embodiments, metadata of the backup data may be corresponding creation time, file size, and the like. Taking “the creation time” as an example, suppose the backup data from the terminal received by the router is: 123.jpg, the file belongs to the type of “picture”, and the creation time is Jul. 30, 2014. When the router adopts the organization structure of the data storage path shown in FIG. 7, suppose the terminal has logged in the account “xiaobai” and the terminal device is “xiaomi 2S”, the data storage path selected by the router is: /Data/xiaobai/xiaomi2S/picture/2014/123.jpg, or /Data/xiaobai/xiaomi2S/picture/2014/07/123.jpg, or /Data/xiaobai/xiaomi2S/picture/2014/07/30/123.jpg, and the like. When the router adopts the organization structure of the data storage path shown in FIG. 8, the data storage path selected by the router is: /Data/picture/xiaobai/xiaomi2S/2014/123.jpg, or /Data/picture/xiaobai/xiaomi2S/2014/07/123.jpg, or /Data/picture/xiaobai/xiaomi2S/2014/07/30/123.jpg, and the like.

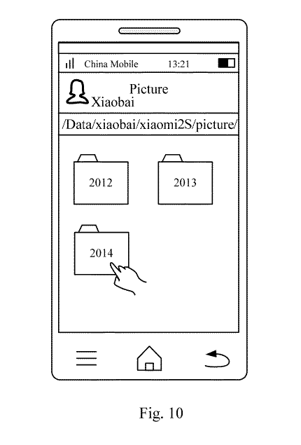

Correspondingly, the user may access the backup data “123.jpg” stored in the router in the following way: the user clicks “picture” button in the terminal interface shown in FIG. 9, and if the router adopts the organization structure of the data storage path shown in FIG. 7, the terminal enters into the data storage path “/Data/xiaobai/xiaomi2S/picture/” corresponding to FIG. 10, and displays folders corresponding to a plurality of sub-paths on the terminal interface; when the user selects a folder “2014” and enters into the sub-path “/Data/xiaobai/xiaomi2S/picture/2014/” shown in FIG. 11, the user may acquire the backup data 123.jpg in the corresponding sub-path “/Data/xiaobai/xiaomi2S/picture/2014/07/” by sliding on the terminal interface and selecting the folder “07”. As shown in FIGS. 9-11, the terminal may display a mobile user interface to control the router. A user may conveniently manipulate the stored data in the router through the mobile user interface.

Corresponding to the embodiment of the aforesaid access processing method, the present disclosure also provides an embodiment of an access processing apparatus.

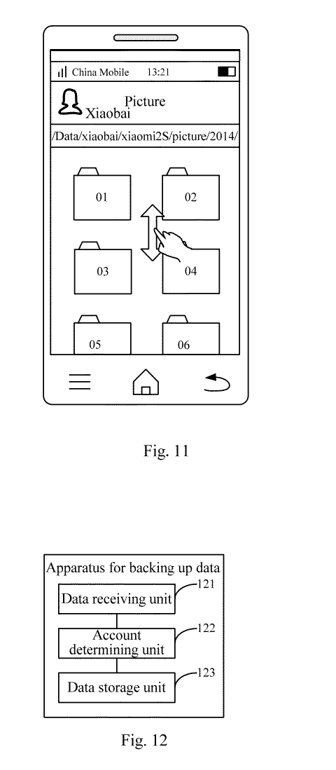

FIG. 12 is a block diagram illustrating an apparatus for backing up data according to an exemplary embodiment. Referring to FIG. 12, the apparatus includes a data receiving unit 121, an account determining unit 122 and a data storage unit 123.

Herein, the data receiving unit 121 is configured to receive backup data from a terminal.

The account determining unit 122 is configured to determine account information that the terminal has logged in.

The data storage unit 123 is configured to store the backup data to a path corresponding to the account information.

In the above described embodiment, the backup data is stored according to the account information, so that access restrictions based on authority may be set between different accounts in advance, thereby improving security and privacy of the backup data, and helping the router to improve the management efficiency to the stored backup data.

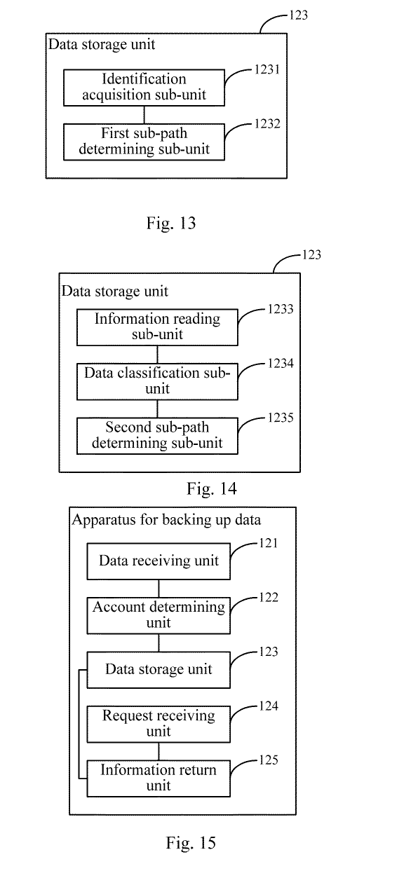

As shown in FIG. 13, FIG. 13 is a block diagram illustrating another apparatus for backing up data according to an exemplary embodiment. The embodiment is based on the aforesaid embodiment shown in FIG. 12. The data storage unit 123 may include: an identification acquisition sub-unit 1231 and a first sub-path determining sub-unit 1232.

Herein, the identification acquisition sub-unit 1231 is configured to acquire a device identification of the terminal.

The first sub-path determining sub-unit 1232 is configured to determine a sub-path corresponding to the device identification under the path corresponding to the account information, and store the backup data to the sub-path corresponding to the device identification.

In the above described embodiment, the stored backup data is managed by combining the account information with the device identification, so that a more detailed storage management to the backup data is realized.

As shown in FIG. 14, FIG. 14 is a block diagram illustrating another apparatus for backing up data according to an exemplary embodiment. The embodiment is based on the aforesaid embodiment shown in FIG. 12. The data storage unit 123 may include: an information reading sub-unit 1233, a data classification sub-unit 1234 and a second sub-path determining sub-unit 1235.

Herein, the information reading sub-unit 1233 is configured to read metadata information of the backup data.

The data classification sub-unit 1234 is configured to classify the backup data according to the metadata information.

The second sub-path determining sub-unit 1235 is configured to determine a sub-path corresponding to a classification result under the path corresponding to the account information, and store the backup data to the sub-path corresponding to the classification result.

In the above described embodiment, the backup data is classified and stored according to the metadata information of the backup data, whereby facilitates a user's finding of the backup data, and also helps the router to improve the management efficiency of the backup data.

As shown in FIG. 15, FIG. 15 is a block diagram illustrating another apparatus for backing up data according to an exemplary embodiment. The embodiment is based on the aforesaid embodiment shown in FIG. 12. The apparatus for backing up data may further include: a request receiving unit 124 and an information return unit 125.

Herein, the request receiving unit 124 is configured to receive a data access request sent by the terminal.

The information return unit 125 is configured to return information of the backup data corresponding to the account information to the terminal according to the data access request.

In the above described embodiment, the information of the backup data corresponding to the account information is only returned according to the account information that the terminal has logged in, thereby facilitating management of the backup data based on the account, and backup data contents of other accounts are also avoided to reveal, which helps to improve the security of the backup data.

It should be noted that, the structure of the request receiving unit 124 and the information return unit 125 in the aforesaid apparatus embodiment shown in FIG. 15 may also be included in any one apparatus embodiment shown in the aforesaid FIG. 12 to FIG. 14, the present disclosure is not limited to this.

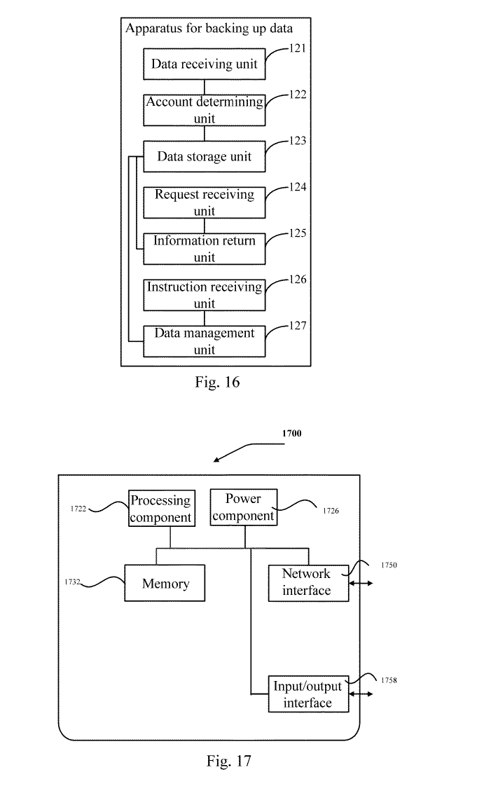

As shown in FIG. 16, FIG. 16 is a block diagram illustrating another apparatus for backing up data according to an exemplary embodiment. The embodiment is based on the aforesaid embodiment shown in FIG. 12. The apparatus for backing up data may further include: an instruction receiving unit 126 and a data management unit 127.

Herein, the instruction receiving unit 126 is configured to receive a data management instruction sent by the terminal.

The data management unit 127 is configured to manage the backup data corresponding to the account information according to the data management instruction.

In the above described embodiment, also uses an account login mechanism so that the user the user may only view and manage the backup data corresponding to the account that has logged in by an account login mechanism, thereby facilitating the router's management of the backup data, and also helping to improve the security of the backup data.

It should be noted that, the structure of instruction receiving unit 126 and the data management unit 127 in the aforesaid apparatus embodiment shown in FIG. 16 may also be included in any one apparatus embodiment shown in the aforesaid FIG. 12 to FIG. 15, the present disclosure is not limited to this.

The detailed implementation process of the function and action of each unit in the above apparatus refers to the implementation process of corresponding steps in the above method, which is no longer described here.

The apparatus embodiment is consistent with the method embodiment, the relevant contents may refer to the descriptions in the method embodiment. The apparatus embodiment described above is only schematic, wherein the unit described as a separated component may be or may also be not physically separated, the component used as a unit display may be or may also be not a physical unit, i.e., it may be located at one place, or may also be distributed in a plurality of network units. Some or all of the modules may be selected to realize the purpose of the present disclosure solution according to the actual needs. Those skilled in the art may understand and implement the present disclosure without any creative labor.

Correspondingly, the present disclosure further provides an access processing apparatus, including: a processor; and a memory for storing instructions executable by the processor. For example, the access processing apparatus may include a router device, a smart router, or other electronic device. The processor is configured to: receive backup data from a terminal; determine account information that the terminal has logged in to the access processing apparatus; and store the backup data to a path corresponding to the account information in the access processing apparatus.

Correspondingly, the present disclosure further provides a router device, including a memory and one or more programs, wherein the one or more programs are stored in the memory, and configured to be executable by one or more processors of the router device. The one or more programs includes instructions to implement actions including: receiving backup data from a terminal; determining account information that the terminal has logged in; and storing the backup data to a path corresponding to the account information.

There is provided a non-transitory computer readable storage medium, wherein when instructions in the storage medium are executed by the processor of a terminal, which may execute a method for backing up data, including: receiving backup data from a terminal; determining account information that the terminal has logged in; and storing the backup data to a path corresponding to the account information.

FIG. 17 is a block diagram of an apparatus 1700 for backing up data according to an exemplary embodiment. For example, the apparatus 1700 may be provided as a server. Referring to FIG. 17, the apparatus 1700 includes a processing component 1722 that further includes one or more processors, and memory resources represented by a memory 1732 for storing instructions, such as application programs, executable by the processing component 1722. The application programs stored in memory 1732 may include one or more modules, each of which corresponds to a set of instructions. Moreover, the processing component 1722 is configured to execute instructions for performing the above described method including:

receiving backup data from a terminal;

determining account information that the terminal has logged in; and

storing the backup data to a path corresponding to the account information.

The apparatus 1700 may also include a power component 1726 configured to perform power management of the apparatus 1700, wired or wireless network interface(s) 1750 configured to connect the apparatus 1700 to a network, and an input/output (I/O) interface 1758. The apparatus 1700 may operate based on an operating system stored in the memory 1732, such as Windows Server™, Mac OS X™, Unix™, Linux™, FreeBSD™, or the like.

After considering this description and carrying out the embodiments disclosed herein, those skilled in the art may easily anticipate other implementation aspects of the present disclosure. The present disclosure is meant to cover any variations, usage or adaptive change of these embodiments, and these variations, usage or adaptive change follow general concept of the present disclosure and include the common knowledge or the customary technical means in the technical field that is not disclosed in the present disclosure. The description and embodiments are only exemplary, and the real range and spirit of the present disclosure are defined by the following claims. The different exemplary embodiments in the disclosure may be combined to create new embodiment without undue experiments by a person having ordinary skill in the art.

It should be understood that the present disclosure is not limited to precise structures that are described above and shown in the accompanying drawings, and may be modified and changed without departing from the range of the present disclosure. The scope of the present disclosure is only defined by the appended claims.

What is claimed is:

1. A method for backing up data, comprising:
receiving, by a router device comprising a processor and a non-transitory storage, backup data from a terminal;
determining, by the router device, account information that the terminal has logged in; and
storing the backup data to a path corresponding to the account information in the non-transitory storage.

2. The method according to claim 1, wherein storing the backup data to the path corresponding to the account information comprises:
acquiring a device identification of the terminal; and
determining a sub-path corresponding to the device identification under the path corresponding to the account information, and storing the backup data to the sub-path corresponding to the device identification.

3. The method according to claim 1, wherein storing the backup data to the path corresponding to the account information comprises:
reading metadata information of the backup data;
classifying the backup data according to the metadata information; and
determining a sub-path corresponding to the classification result under the path corresponding to the account information, and storing the backup data to the sub-path corresponding to the classification result.

4. The method according to claim 1, further comprising:
receiving a data access request sent from the terminal; and
returning information of the backup data corresponding to the account information to the terminal according to the data access request.

5. The method according to claim 4, further comprising:
receiving a data management instruction sent from the terminal; and
managing the backup data corresponding to the account information according to the data management instruction.

6. An electronic device, comprising:
a processor; and
a memory for storing instructions executable by the processor;
wherein the processor is configured to perform:
receiving backup data from a terminal;
determining account information that the terminal has logged in to the electronic device; and
storing the backup data to a path corresponding to the account information in a non-transitory storage of the electronic device.

7. The electronic device according to claim 6, wherein storing the backup data to the path corresponding to the account information comprises:
acquiring a device identification of the terminal; and
determining a sub-path corresponding to the device identification under the path corresponding to the account information, and storing the backup data to the sub-path corresponding to the device identification.

8. The electronic device according to claim 6, wherein storing the backup data to the path corresponding to the account information comprises:
reading metadata information of the backup data;
classifying the backup data according to the metadata information; and
determining a sub-path corresponding to the classification result under the path corresponding to the account information, and storing the backup data to the sub-path corresponding to the classification result.

9. The electronic device according to claim 6, wherein the processor is further configured to perform acts comprising:
receiving a data access request sent from the terminal; and
returning information of the backup data corresponding to the account information to the terminal according to the data access request.

10. The electronic device according to claim 9, wherein the processor is further configured to perform acts comprising:
receiving a data management instruction sent from the terminal; and
managing the backup data corresponding to the account information according to the data management instruction.

11. A non-transitory computer readable storage medium configured to store instructions to be executed by a router device, the instructions causing the router device to perform actions comprising:
receiving backup data from a terminal;
determining account information that the terminal has logged in to the router device; and
storing the backup data to a path corresponding to the account information in the router device.

12. The non-transitory computer readable storage medium according to claim 11, wherein the instructions cause the router device to perform actions comprising:
acquiring a device identification of the terminal; and
determining a sub-path corresponding to the device identification under the path corresponding to the account information, and storing the backup data to the sub-path corresponding to the device identification.

13. The non-transitory computer readable storage medium according to claim 11, wherein the instructions cause the router device to perform actions comprising:
reading metadata information of the backup data;
classifying the backup data according to the metadata information; and
determining a sub-path corresponding to the classification result under the path corresponding to the account information, and storing the backup data to the sub-path corresponding to the classification result.

14. The non-transitory computer readable storage medium according to claim 11, wherein the instructions cause the router device to perform actions comprising:
receiving a data access request sent from the terminal; and
returning information of the backup data corresponding to the account information to the terminal according to the data access request.

15. The non-transitory computer readable storage medium according to claim 14, wherein the instructions cause the router device to perform actions comprising:
receiving a data management instruction sent from the terminal; and
managing the backup data corresponding to the account information according to the data management instruction.
